(19) United States
(12) Patent Application Publication
(10) Pub. No.: US 2008/0313806 A1
(43) Pub. Date: Dec. 25, 2008

(54) Transferring device for bed

(76) Inventor: Yu-Wen Cheng, Taichung City (TW)

Correspondence Address: PRO-TECHTOR INTERNATIONAL SERVICES, 20775 NORADA CT., SARATOGA, CA, 95070, US

(21) Appl. No.: 11/821,185

(22) Filed: Jun. 22, 2007

(51) Int. Cl. A61G 7/10; A47C 27/10

(52) U.S. Cl. 5/81.1 R

(57) ABSTRACT

A transferring device for a bed, placed on a bed plate, on top of or below a mattress, comprises inner and outer inflatable bags. Both inner and outer inflatable bag are placed on said bed plate, are shaped like a comb and each have a main inflatable bag and several auxiliary inner inflatable bags which are connected with each other, while being spatially separated from each other by gaps. By inflating and deflating the inner and outer inflatable bags, a patient is easily moved on the bed plate as well as transferred onto or from the bed plate.

### FIELD OF THE INVENTION

The present invention relates to a transferring device for a bed, particularly to a transferring device for a bed for facilitating moving of a patient into and out of a bed.

### BACKGROUND OF THE INVENTION

Moving a severely sick or disabled patient into or out of a bed is a difficult and bothersome task. Conventionally, this task is alleviated by using a mattress with a smooth lower surface to minimize friction. Even then, a lot of physical effort is required. If the bed is not movable or placed next to a wall, moving the patient is even harder.

### SUMMARY OF THE INVENTION

It is the object of the present invention to provide a transferring device for a bed for moving a patient into and out of the bed with minimal physical effort.

For achieving above object, the present invention comprises inner and outer inflatable bags. Both inner and outer inflatable bag are placed on said bed plate, are shaped like a comb and each have a main inflatable bag and several auxiliary inner inflatable bags which are connected with each other, while being spatially separated from each other by gaps. By inflating and deflating the inner and outer inflatable bags, a patient is easily moved on the bed plate as well as transferred onto or from the bed plate.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a front view of the transferring device of the present invention in conjunction with a bed.

FIG. 2 is a top view of the transferring device of the present invention, with the mattress having been removed.

FIG. 3 is a top view of the inner inflatable bag of the present invention, with the mattress having been removed.

FIGS. 4a-4d are schematic illustrations of the movement of the present invention.

FIG. 5 is a schematic illustration of the movement of the present invention when transferring a patient between the bed and a stretcher.

FIG. 6 is a front view of the present invention with additional parts of the inflatable bags.

FIG. 7 is a perspective view of the inner inflatable bag of the present invention in the second embodiment.

FIG. 8 is a perspective view of the outer inflatable bag of the present invention in the second embodiment.

### DESCRIPTION OF THE PREFERRED EMBODIMENTS

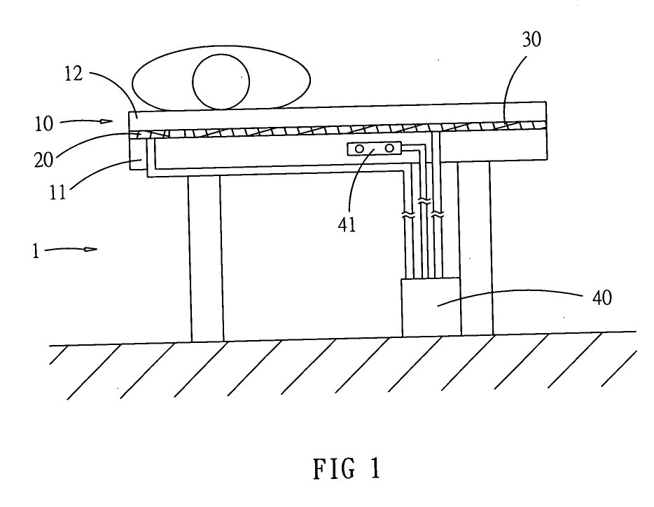

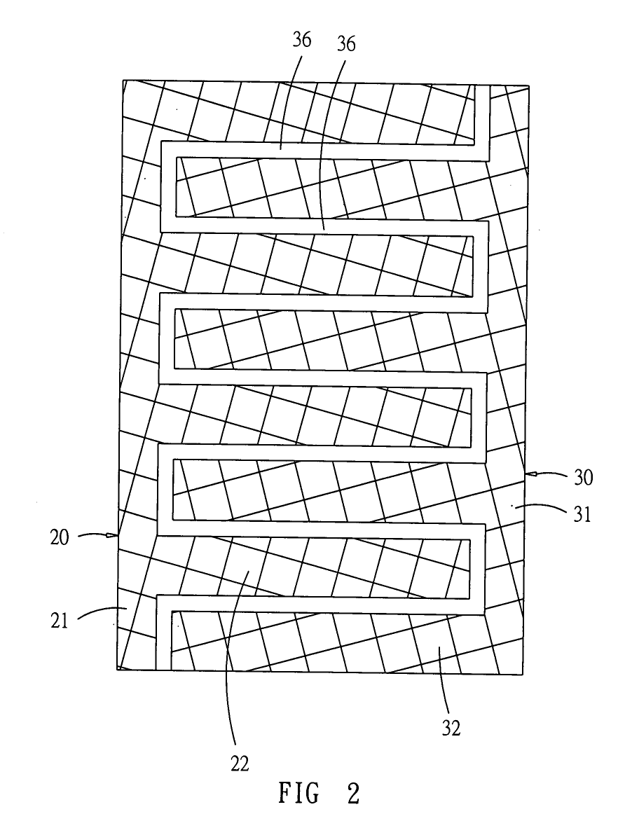

As shown in FIG. 1-3, the present invention is a transferring device 10 for a bed, used in conjunction with a bed 1 having a bed plate 11 and a mattress 12 and comprising: an inner inflatable bag 20, placed on the bed plate 11; an outer inflatable bag 30, placed on the bed plate 11 and crossing over the inner inflatable bag 20; and a compressor 40 for inflating and deflating the inner and outer inflatable bags 20, 30. By inflating and deflating the inner and outer inflatable bags 20, 30, height differences between various areas of the bed 1 are generated, allowing conveniently to move a patient on the bed as well as into and out of the bed. In the following, a detailed description is given.

The inner inflatable bag 20 is shaped like a comb and comprises a main inner inflatable bag 21 and several auxiliary inner inflatable bags 22, which are connected with the main inner inflatable bag 21 and separated therefrom by gaps 24. After inflating the inner inflatable bag 20, the main inner inflatable bag 21 assumes a triangular shape with a height that exceeds heights of the auxiliary inner inflatable bags 22, which have triangular shapes, as well.

Similarly, the outer inflatable bag 30 is shaped like a comb and comprises a main outer inflatable bag 31 and several auxiliary outer inflatable bags 32, which are connected with the main outer inflatable bag 31 and separated therefrom by gaps 34. After inflating the outer inflatable bag 30, the main outer inflatable bag 31 assumes a triangular shape with a height that exceeds heights of the auxiliary outer inflatable bags 32, which have triangular shapes, as well. The auxiliary inner inflatable bags 22 and the auxiliary outer inflatable bags 32 are separated by gaps and arranged in a cross-like pattern, on which the patient lies when placed in the bed.

For keeping the inner and outer inflatable bags 20, 30 free from dirt, the mattress 12 is placed on top thereof.

The compressor 40 has a switch 41 which is operated by the patient or an assisting person for inflating and deflating the inner and outer inflatable bags 20, 30.

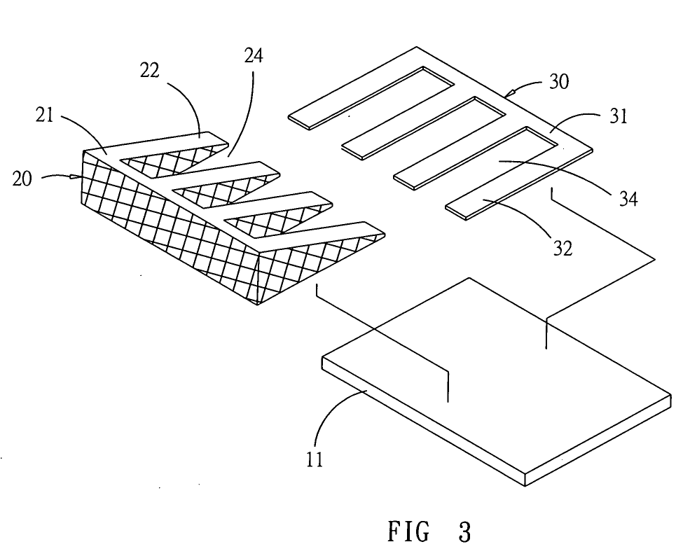

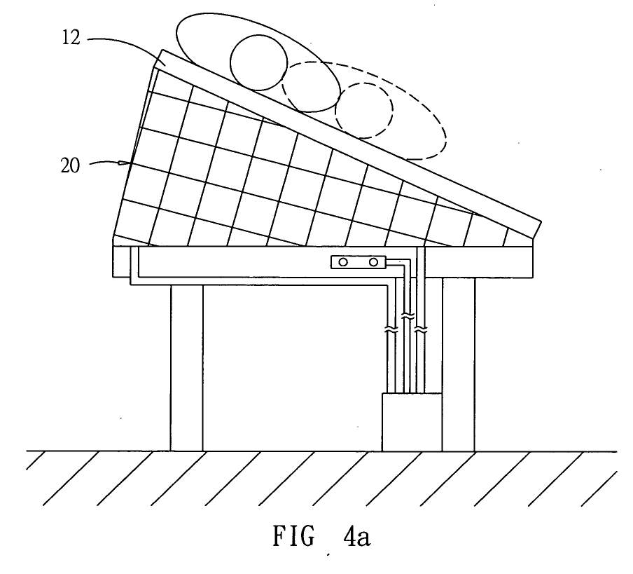

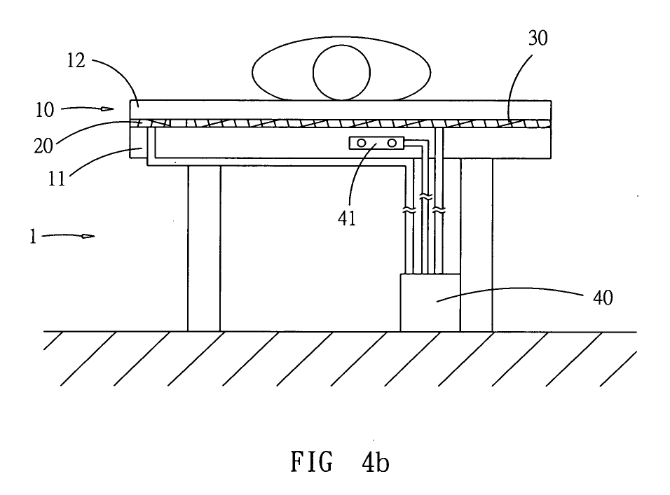

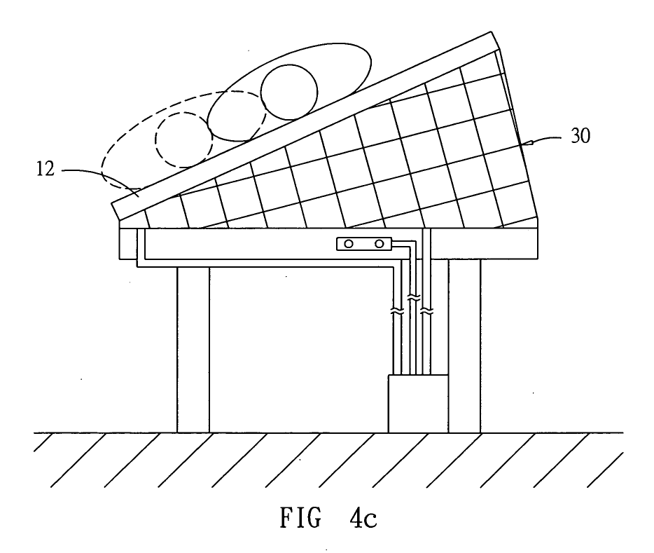

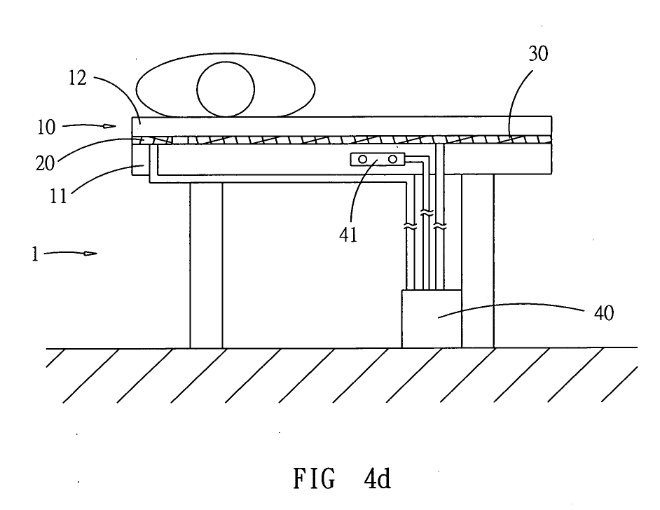

Referring to FIGS. 3 and 4a -4d, for moving the patient between an inner edge of the bed 1 and an outer edge thereof, e.g., for the purpose of replacing bandages or washing the patient, the inner and outer inflatable bags 20, 30 are inflated and deflated in turns. For example, to move the patient away from the inner edge of the bed 1, the main inner inflatable bag 21 is inflated, as shown in FIG. 4a, so that the patient is easily moved from the inner edge of the bed 1 to a central position on the bed 1. Subsequently, the inner inflatable bag 20 is deflated, as shown in FIG. 4b. Similarly, to move the patient away from the outer edge of the bed 1, the outer inflatable bag 30 is inflated, as shown in FIG. 4c, and the patient is easily moved towards the outer edge of the bed 1. After that, the outer inflatable bag 30 is deflated, as shown in FIG. 4d.

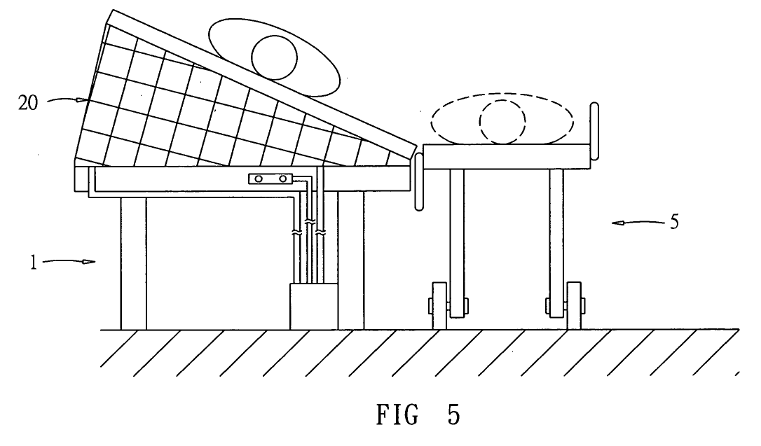

Referring to FIG. 5, for transferring the patient from the bed 1 to a stretcher 5, the stretcher 5 is first placed next to the outer edge of the bed 1, then the inner inflatable bag 20 is inflated, and the patient is moved towards the outer edge of the bed 1 and on to the stretcher 5.

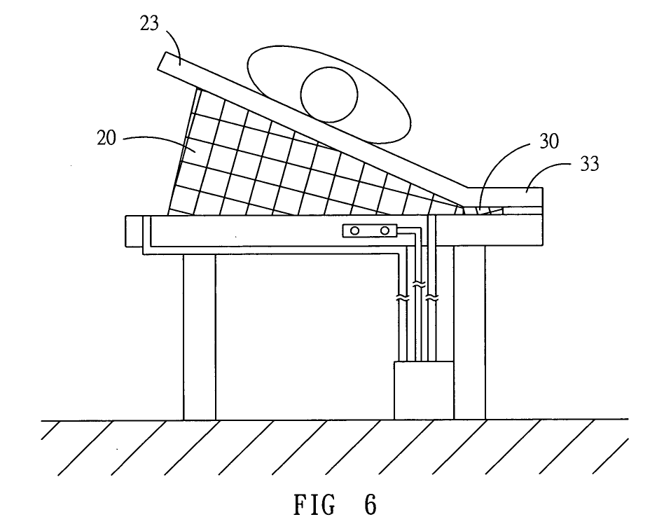

As shown in FIG. 6, additional parts 23, 33 are optionally attached to the inner and outer inflatable bags 20, 30, respectively, to specify areas of convenient moving of the patient.

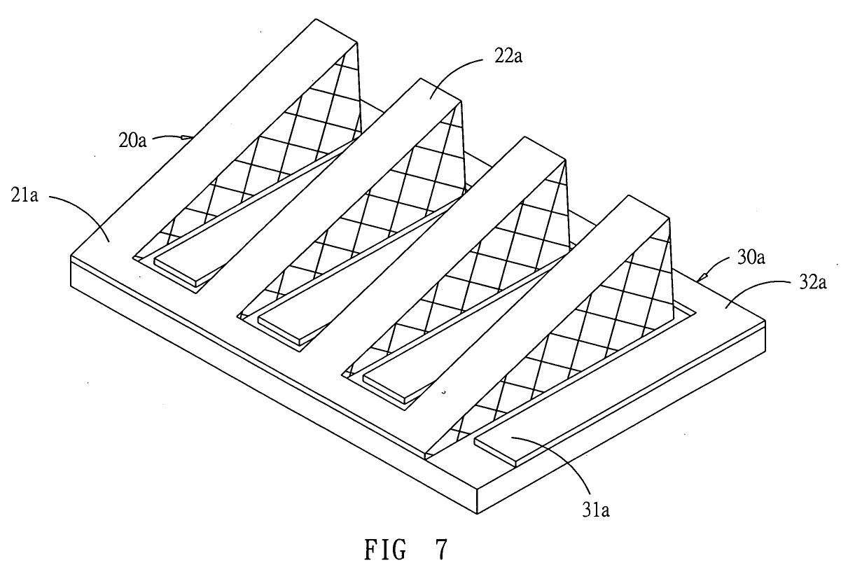

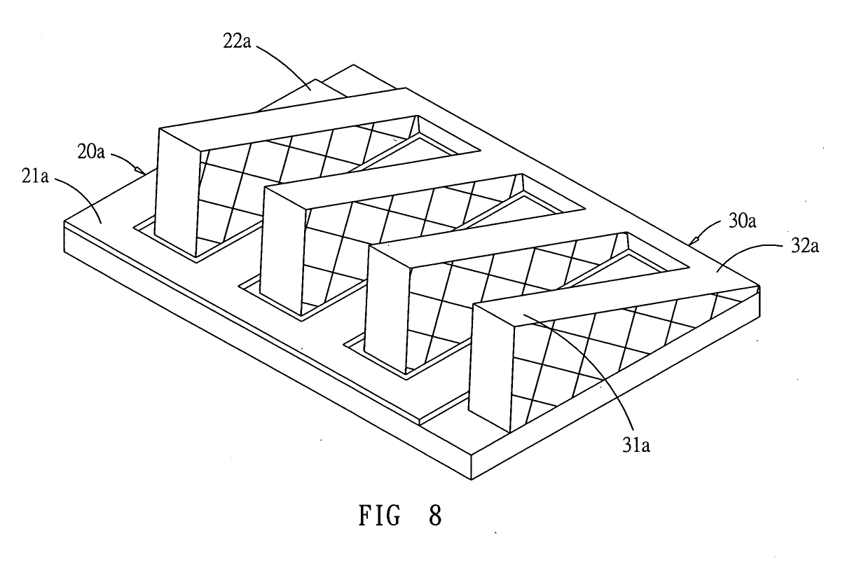

Referring to FIGS. 7 and 8, the present invention in a second embodiment has inner and outer inflatable bags 20a, 30a with a main inner inflatable bag 21a that is lower than connected auxiliary inner inflatable bags 22a when inflated, and a main outer inflatable bag 31a that is lower than connected auxiliary outer inflatable bags 32a when inflated, so that a different pattern of height differences results.

While preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A transferring device for a bed, placed on a bed plate, comprising:
an inner inflatable bag; placed on said bed plate, shaped like a comb and having a main inner inflatable bag and several auxiliary inner inflatable bags which are connected thereto and spatially separated therefrom by gaps, with said main inner inflatable bag having a triangular shape with a main height and said auxiliary inner inflatable bags having triangular shapes with auxiliary heights that are less than said main height;
an outer inflatable bag; placed on said bed plate shaped like a comb and having a main outer inflatable bag and several auxiliary outer inflatable bags which are connected thereto and spatially separated therefrom by gaps, with said main outer inflatable bag having a triangular shape with a main height and said auxiliary outer inflatable bags having triangular shapes with auxiliary heights that are less than said main height, with said inner and outer inflatable bags forming a cross-like pattern, leaving gaps in between; and
a compressor for inflating and deflating said inner and outer inflatable bags.

2. A transferring device for a bed, placed on a bed plate, comprising:
an inner inflatable bag; placed on said bed plate, shaped like a comb and having a main inner inflatable bag and several auxiliary inner inflatable bags which are connected thereto and spatially separated therefrom by gaps, with said main inner inflatable bag having a triangular shape with a main height and said auxiliary inner inflatable bags having triangular shapes with auxiliary heights that are less than said main height;
an outer inflatable bag; placed on said bed plate shaped like a comb and having a main outer inflatable bag and several auxiliary outer inflatable bags which are connected thereto and spatially separated therefrom by gaps, with said main outer inflatable bag having a triangular shape with a main height and said auxiliary outer inflatable bags having triangular shapes with auxiliary heights that are greater than said main height, with said inner and outer inflatable bags forming a cross-like pattern, leaving gaps in between; and
a compressor for inflating and deflating said inner and outer inflatable bags.

3. The transferring device for a bed according to claim 1, wherein a mattress is laid on said inner and outer inflatable bags.

4. The transferring device for a bed according to claim 2, wherein a mattress is laid on said inner and outer inflatable bags.

5. The transferring device for a bed according to claim 1, wherein additional parts are added to inner and outer inflatable bags.

6. The transferring device for a bed according to claim 1, wherein additional parts are added to inner and outer inflatable bags.
